(19) United States
(12) Patent Application Publication
(10) Pub. No.: US 2016/0367417 A1
(43) Pub. Date: Dec. 22, 2016

(54) WHEELCHAIR AND WALKER CONNECTION APPARATUS

(71) Applicant: Hannah Ramirez, Zapata, TX (US)

(72) Inventor: Hannah Ramirez, Zapata, TX (US)

(21) Appl. No.: 14/741,917

(22) Filed: Jun. 17, 2015

(51) Int. Cl. A61G 5/10; F16B 7/10; F16B 7/04

(52) U.S. Cl. CPC A61G 5/10; F16B 7/0433; F16B 7/105

(57) ABSTRACT

A wheelchair and walker connection apparatus for selectively fixing a walker to a wheelchair. The wheelchair and walker connection apparatus includes a first attachment hook and a second attachment hook, each defining mirror image attaching assemblies, and an adjustable linking bar disposed between the respective attachment hooks. The adjustable linking bar telescopically extendable between, and selectively fixed in, an extended position and a retracted position. The attachment hooks each include a tightening screw which enables it, through the engagement of the screw, to selectively exert holding pressure on a structure which is present in the open area formed by the hook shape of the respective attachment hook.

### BACKGROUND OF THE INVENTION

Field of the Invention

This invention relates generally to coupling devices and, more particularly, to a connection apparatus for releasably securing a walker to a wheelchair.

Description of the Prior Art

The use of conventional walkers and conventional wheelchairs by individuals who have problems moving around is well known. Walkers typically define a portable frame member which is grasped for added support while a user is walking. Wheelchairs customarily define a chair which includes wheels and is either manually or electrically propelled. For individuals having limited mobility, whether from injury, disability, or old age, it is common for both walkers and wheelchairs to be utilized for various tasks or in varying circumstances.

A problem which still exists, however, is that when a user desires to move from their wheelchair to their walker, the transition can be very difficult to safely accomplish without assistance. Because both devices are inherently portable, it is often necessary to have a therapist or caregiver help stabilize one or both of the walker or wheelchair while a user seeks to transition from one to the other to prevent the user from falling. Thus, there remains a need for a wheelchair and walker connection apparatus which would allow a walker to be selectively fixed to a wheelchair and thereby secure the walker's position relative to the wheelchair. It would be helpful if such a connection apparatus included an adjustable length so as to be adaptable to various sized wheelchairs and walkers. It would be additionally desirable for such a connection apparatus to have discrete attachment sections for a wheelchair and a walker, each of which were tightened and loosened separately.

The Applicant's invention described herein provides for a wheelchair and walker connection apparatus adapted to allow a user to selectively fix a walker to a wheelchair. The primary components in Applicant's connection apparatus are a first attachment hook, an adjustable linking bar, and a second attachment hook. When in operation, the wheelchair and walker connection apparatus enables a walker to be fixed to a wheelchair to increase the ease in which it can be transported as well as improve the ease in which a user in the wheelchair can transition to using the walker. As a result, many of the limitations imposed by prior art structures are removed.

### SUMMARY OF THE INVENTION

A wheelchair and walker connection apparatus for selectively fixing a walker to a wheelchair. The wheelchair and walker connection apparatus includes a first attachment hook and a second attachment hook, each defining mirror image attaching assemblies, and an adjustable linking bar disposed between the respective attachment hooks. The adjustable linking bar telescopically extendable between, and selectively fixed in, an extended position and a retracted position. The attachment hooks each include a tightening screw which enables it, through the engagement of the screw, to selectively exert holding pressure on a structure which is present in the open area formed by the hook shape of the respective attachment hook.

Accordingly, the first attachment hook can be fixed to a leg of a wheelchair, engaging the tightening screw such that it fixedly holds the leg and the second attachment hook can be attached to the leg of the walker with the second tightening screw engaged until it exerts sufficient holding pressure on the leg that it holds it in place, to couple the wheelchair and walker.

It is an object of this invention to provide a wheelchair and walker connection apparatus which would allow a walker to be selectively fixed to a wheelchair and thereby secure the walker's position relative to the wheelchair.

It is another object of this invention to provide a wheelchair and walker connection apparatus that is adjustable in length so as to be adaptable to various sized wheelchairs and walkers.

It is yet another object of this invention to provide a wheelchair and walker connection apparatus having discrete attachment sections for a wheelchair and a walker, each of which were tightened and loosened separately.

These and other objects will be apparent to one of skill in the art.

### BRIEF DESCRIPTION OF THE DRAWINGS

FIG. 1 is a front side elevational view of a wheelchair and walker connection apparatus built in accordance with the present invention in an extended position.

FIG. 2 is a front side elevational view of a wheelchair and walker connection apparatus built in accordance with the present invention in a retracted position.

FIG. 3 is a left side elevational view of a wheelchair and walker connection apparatus built in accordance with the present invention in a retracted position

### DETAILED DESCRIPTION OF THE INVENTION

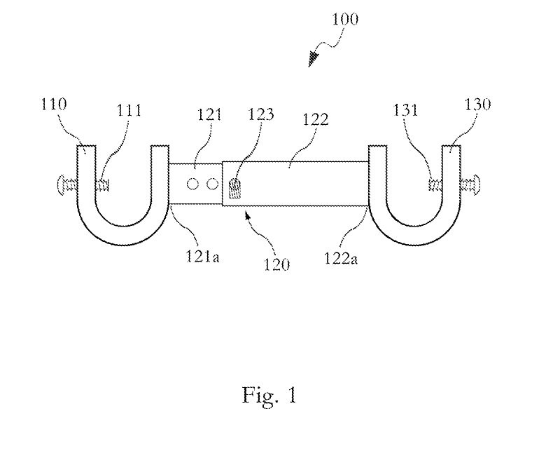

Referring now to the drawings and in particular FIGS. 1, 2, and 3, a wheelchair and walker connection apparatus 100 is shown having a first attachment hook 110, an adjustable linking bar 120, and a second attachment hook 130. The first attachment hook 110 and the second attachment hook 130 define mirror image attaching assemblies which are each integral with the adjustable linking bar 120. The adjustable linking bar 120 defines a rigid, elongated member having a first section 121 telescopically disposed in a second section 122. The adjustable linking bar 120 has a first end 121a which defines the end of the first section 121 opposite the second section 122 and a second end 122a defines the end of the second section 122 opposite the first section 121.

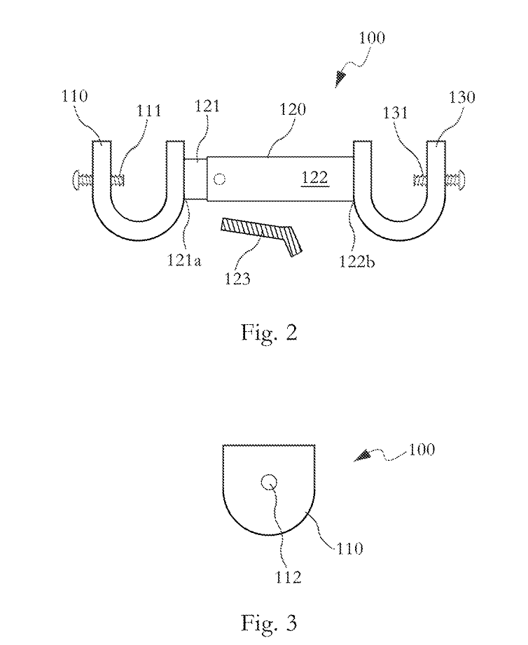

The adjustable linking bar 120 can be moved between and selectively fixed in an extended position, as illustrated in FIG. 1, and a retracted position, as illustrated in FIG. 2, through the sliding the first section 121 telescopically in or out of the second section 122 and inserting a fixing rod 123 through the aligned apertures of the first section 121 and second section 122.

The first attachment hook 110 is permanently attached to the first end 121a and includes an open end formed by its hook shape that faces perpendicular relative to the planar direction of the adjustable linking bar 120. A tightening screw 111 is integral with the first attachment hook 110 such that it can be selectively screwed through a tightening aperture 112 in the exterior of the first attachment hook 110 into the open area formed by the hook shape of the first attachment hook 110. The tightening screw 111 thereby can exert holding pressure on a structure which is present in the open area formed by the hook shape of the first attachment hook 110.

The second attachment hook 130 is permanently attached to the second end 121a and includes an open end formed by its hook shape that faces perpendicular relative to the planar direction of the adjustable linking bar 120. A second tightening screw 131 is integral with the second attachment hook 130 such that it can be selectively screwed through a second tightening aperture (not shown) in the exterior of the second attachment hook 130 into the open area formed by the hook shape of the second attachment hook 130. The second tightening screw 131 thereby can exert holding pressure on a structure which is present in the open area formed by the hook shape of the second attachment hook 130.

In operation, the wheelchair and walker connection apparatus 100 is utilized to selectively attach a walker to a wheelchair by attaching the first attachment hook 110 to a leg of the wheelchair (or walker) and engaging the tightening screw 111 such that it fixedly holds the leg. The second attachment hook 130 is then attached to the leg of the walker (or wheelchair, meaning the opposite of the device to which the first attachment hook 110 was fixed) and the second tightening screw 131 is engaged until it exerts sufficient holding pressure on the leg that it holds it in place.

In an alternate embodiment, the tightening screws 111, 131 are used to trap the walker/wheelchair leg against the interior surface of the respective attachment hook 110, 130 instead of exerting holding pressure directly on the leg.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A connection apparatus for selectively coupling a walker to a wheelchair, comprising:
a linking bar defining an elongated member having a first end and a second end;
a first attachment assembly integral with the first end, wherein said first attachment assembly is configured to be selectively fixed to the body of at least one of a wheelchair and a walker; and
a second attachment assembly integral with the second end, wherein said second attachment assembly is configured to be selectively fixed to the body of at least one of a wheelchair and a walker.

2. The connection apparatus of claim 1, wherein said linking bar includes rigid first section telescopically disposed in a rigid second section, thereby enabling the length of the linking bar to be selectively adjusted.

3. The connection apparatus of claim 2, additionally comprising a fixing rod operative to fix the first section in place relative to the second section.

4. The connection apparatus of claim 1, wherein said first attachment assembly defines a first attachment hook having an integral tightening screw.

5. The connection apparatus of claim 4, wherein said second attachment assembly defines a second attachment hook having an integral second tightening screw

6. A connection apparatus for selectively coupling a walker to a wheelchair, comprising:
a telescopic adjustable linking bar defining an elongated member having a first end and a second end;
a first attachment assembly integral with the first end, wherein said first attachment assembly is configured to be selectively fixed to the body of at least one of a wheelchair and a walker;
a second attachment assembly integral with the second end, wherein said second attachment assembly is configured to be selectively fixed to the body of at least one of a wheelchair and a walker; and
wherein at least one of said first attachment assembly and said second attachment assembly defines an attachment hook having an integral tightening screw.

7. The connection apparatus of claim 6, additionally comprising a fixing rod operative to fix the first section in place relative to the second section.

8. The connection apparatus of claim 7, wherein each of said first attachment assembly and said second attachment assembly defines an attachment hook having an integral tightening screw.

9. The connection apparatus of claim 6, wherein each of said first attachment assembly and said second attachment assembly defines an attachment hook having an integral tightening screw.

10. The connection apparatus of claim 6, wherein said adjustable linking bar includes rigid first section telescopically disposed in a rigid second section.
